(19) United States
(12) Patent Application Publication
(10) Pub. No.: US 2011/0184977 A1
(43) Pub. Date: Jul. 28, 2011

(54) RECOMMENDATION METHOD AND SYSTEM BASED ON COLLABORATIVE FILTERING

(76) Inventors: Jiachun Du, Shenzhen (CN); Fangshan Wang, Shenzhen (CN); Qi Fang, Shenzhen (CN); Weiguo Tan, Shenzhen (CN); Jieping Zhong, Shenzhen (CN)

(21) Appl. No.: 13/072,155

(22) Filed: Mar. 25, 2011

Related U.S. Application Data
(63) Continuation of application No. PCT/CN2009/073275, filed on Aug. 14, 2009.

(30) Foreign Application Priority Data
Sep. 27, 2008 (CN) 200810216517.9

(51) Int. Cl. G06F 17/30

(52) U.S. Cl. 707/769; 707/E17.014

(57) ABSTRACT

A recommendation method based on collaborative filtering is provided, which includes the following steps. A target user identifier (ID) is acquired. A user group ID corresponding to the target user ID is searched. A similarity between items is acquired, which is determined according to a user-item rating matrix corresponding to the user group M. An item is recommended to a target user according to the similarity between the items.

### CROSS-REFERENCE TO RELATED APPLICATIONS

This application is a continuation of International Application No. PCT/CN2009/073275, filed on Aug. 14, 2009, which claims priority to Chinese Patent Application No. 200810216517.9, filed on Sep. 27, 2008, both of which are hereby incorporated by reference in their entireties.

### FIELD OF THE TECHNOLOGY

The present invention relates to the field of network communication technologies, and more particularly, to a recommendation method and system base on collaborative filtering.

### BACKGROUND OF THE INVENTION

A recommendation system is an intelligent agent system proposed to solve the information overload problem, which can automatically recommend to a user resources catering for the interests and preference or demands of the user from a large quantity of information. With the popularization and rapid development of the Internet, the recommendation system has been widely applied in various fields, especially in the electronic commerce field, where increasing researches and applications are made to the recommendation system. Currently, almost all the large electronic commerce web sites, such as Amazon, CDNOW, eBay, and Dangdang online bookstore, are using various forms of recommendation systems to a different extent. The collaborative filtering technology is successfully applied in the current recommendation system.

Collaborative filtering algorithms mainly include a user-based collaborative filtering algorithm and an item-based collaborative filtering algorithm. Inputs of both algorithms are matrixes of ratings made by users for items, as shown in Table 1:

TABLE 1
Matrix of ratings made by users for items

| | Item | | | | | | | |
|---|---|---|---|---|---|---|---|---|
| | Item | Item | Item | Item | Item | Item | Item | Item |
| User | 1 | 2 | 3 | 4 | 5 | 6 | 7 | 8 |
| User 1 | 5 | 3 | 4 | | | | | |
| User 2 | 4 | 2 | | 5 | | | | |
| User 3 | | 3 | 5 | 3 | | | | |
| User 4 | 4 | | 5 | 4 | | | | |
| User 5 | | | | 5 | | 3 | 5 | 2 |
| User 6 | | | 3 | | | 4 | 5 | |
| User 7 | | | 2 | 4 | | | 4 | 5 |
| User 8 | | | 3 | 5 | 4 | 5 | 4 | 3 |
| User 9 | | | 5 | 4 | | | 5 | |

The rating made by a user for an item may be explicitly obtained, for example, through a rating operation performed by the user on the item; and may also be implicitly obtained, for example, by calculation with a rating function constructed through behaviors of the user like searching, browsing, and purchasing of the item. The vectors formed in each row of the matrix represent the rating vectors of the user corresponding to the row for each item.

The basic principle of the user-based collaborative filtering algorithm utilizes similarities of item ratings made by the users to mutually recommend items that the users may be interested in. For example, for a current user U, through rating records of the user U and a particular similarity function, the system calculates k users that are the closest to the rating behavior of the user U as the closest neighbor set of the user U, makes statistics on items that the neighboring users of the user U rate while the user U does not rate, to generate a candidate recommendation set, then calculates a predicted rating made by the user U for each item i in the candidate recommendation set, and takes N items with the highest predicted rating as a Top-N recommendation set of the user U.

The item-based collaborative filtering algorithm compares a similarity between items, and recommends an item that has not been rated according to a set of items already rated by the current user. The similarity between the items is more stable than the similarity between the users, so the similarity between the items can be offline calculated and stored and periodically updated. Thus, relative to the user-based collaborative filtering algorithm, the item-based collaborative filtering algorithm has a high recommendation precision and a good real-time performance. The item-based collaborative filtering algorithm, after being optimized, may achieve higher recommendation accuracy and a better effect, and better conform to the demands of the user.

A basic processing procedure of item-based collaborative recommendation is divided into two parts: offline similarity calculation and online recommendation. FIG. 1 shows an offline similarity calculation procedure in an item-based collaborative recommendation method, and FIG. 2 shows an online recommendation procedure in an item-based collaborative recommendation method.

The offline similarity calculation procedure in FIG. 1 is employed to calculate and save the similarity between the items. In step 1, a matrix of ratings made by each user for each item is acquired. In step 2, the similarity between the items is calculated, where a similarity function using a cosine similarity or Pearson correlation coefficient may be adopted. In step 3, the similarity between different items is stored.

On the basis of calculating and storing the similarity between the different items in advance, as shown in FIG. 2, the online recommendation procedure includes the following steps. In step 11, a user identifier (ID) to be recommended, that is, a target user ID, is acquired. In step 12, a set of items rated by a target user corresponding to the target user ID is acquired. In step 13, according to item similarity data stored in advance, items with a high similarity to each item in the set of the items rated by the target user are acquired, so as to form a set of items to be recommended of the target user. In step 14, according to the similarity between the items, a predicted rating made by the target user for each item in the set of the items to be recommended is further calculated, for example, the predicted rating is calculated according to the following formula:

$${P}_{U \cdot i} = \frac{\sum sim ( j , i ) \cdot {R}_{U \cdot j}}{\sum sim ( j , i )} ,$$

where P_{U,i} denotes a predicted rating made by a target user U for an item i, sim(j,i) denotes a similarity between an item j and an item i, and R_{I,j} denotes an actual rating made by the user U for the item j . In step 15, according to a predicted rating result, the top N items with the highest rating are taken as a recommendation result for the target user.

In the procedure of the item-based collaborative filtering algorithm, the similarity between the items has critical influence on the final recommendation result. In the conventional item-based collaborative filtering recommendation algorithm, the calculation of the similarity between the items does not consider the difference between user groups of different preferences. The similarity between the items is calculated based on the user rating matrix. For all users, the similarity between the same two items is identical. However, in practice, for the opinions of the same two items, the viewpoints of user groups of different preferences are generally different, which inevitably reduces the recommendation accuracy and degrades the quality.

### SUMMARY OF THE INVENTION

To improve the accuracy of recommendation and conform to the user preference, the present invention is directed to a recommendation method and system based on collaborative filtering.

A recommendation method based on collaborative filtering includes the following steps. A target user ID is acquired. A user group ID corresponding to the target user ID is searched. A similarity between items is acquired, where the similarity between items is determined according to a user-item rating matrix corresponding to the user group D. An item is recommended to a target user according to the similarity between the items.

A recommendation system based on collaborative filtering includes a recommendation control module, a set-to-be-recommended determination module, and a recommendation generation module. The recommendation control module is configured to acquire a target user ID, and invoke the set-to-be-recommended determination module and the recommendation generation module to recommend an item to a target user corresponding to the target user ID. The set-to-be-recommended determination module is configured to search a user group ID corresponding to the target user ID, acquire a similarity between items, where the similarity between items is determined according to a user-item rating matrix corresponding to the user group ID, determine, according to the similarity between the items, a set to be recommended, or acquire a set of hotspot items, where the set of hotspot items is determined according to the user-item rating matrix corresponding to the user group ID, and use the set of the hotspot items as the set to be recommended. The recommendation generation module is configured to recommend an item in the set to be recommended to a user.

With the recommendation method and system based on collaborative filtering according to embodiments of the present invention, users are firstly grouped, so that preferences of the users in each user group are substantially the same, and item similarity information contained in each user group is utilized to recommend items for the users, thereby improving the accuracy of recommendation and realizing personalized recommendation.

### BRIEF DESCRIPTION OF THE DRAWINGS

FIG. 1 shows an offline similarity calculation procedure in an item-based collaborative recommendation method in the prior art;

FIG. 2 shows an online recommendation procedure in an item-based collaborative recommendation method in the prior art;

FIG. 3 is a schematic structural view of a recommendation system based on collaborative filtering according to an embodiment of the present invention;

FIG. 4 is a schematic flow chart of user grouping in a procedure of a recommendation method based on collaborative filtering according to an embodiment of the present invention;

FIG. 5 is a schematic flow chart of calculating a similarity between items in a procedure of a recommendation method based on collaborative filtering according to an embodiment of the present invention;

FIG. 6 is a schematic flow chart of calculating a hotspot level of an item in a procedure of a recommendation method based on collaborative filtering according to an embodiment of the present invention;

FIG. 7 is a schematic flow chart of establishing a categorizer in a procedure of a recommendation method based on collaborative filtering according to an embodiment of the present invention;

FIG. 8 is a schematic flow chart of online recommendation in a procedure of a recommendation method based on collaborative filtering according to an embodiment of the present invention; and

FIG. 9 is a schematic flow chart of a recommendation method based on collaborative filtering according to an embodiment of the present invention.

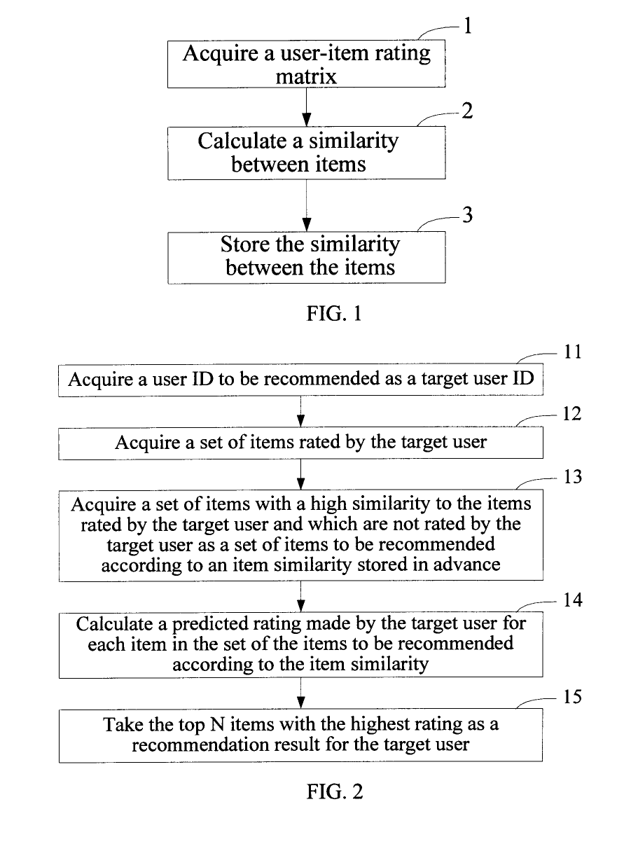

### DETAILED DESCRIPTION OF THE EMBODIMENTS

The technical solutions of the present invention are described in detail below with reference to the embodiments and the accompanying drawings.

In an embodiment, the present invention provides a recommendation method based on collaborative filtering, where the method includes the following steps. Firstly, users are grouped based on a user-item rating matrix, and each user group only includes data of ratings made by the users for all items in the group. Then, a similarity between items is independently calculated for each user group. Finally, recommendation is performed for a target user based on the similarity calculated in the group to which the target user belongs.

In an embodiment, the present invention provides a recommendation system based on collaborative filtering. The system includes: a recommendation control module, configured to acquire a target user identifier, and invoke a set-to-be-recommended determination module and a recommendation generation module to recommend an item to a target user corresponding to the target user identifier; the set-to-be-recommended determination module, configured to search a user group identifier corresponding to the target user identifier, acquire a similarity between items, where the similarity between items is determined according to a user-item rating matrix corresponding to the user group identifier, determine, according to the similarity between the items, the set to be recommended, or acquire a set of hotspot items, where the set of hotspot items is determined according to the user-item rating matrix corresponding to the user group identifier, and use the set of the hotspot items as the set to be recommended; and the recommendation generation module, configured to recommend an item in the set to be recommended to a user. The foregoing is described in detail as follows.

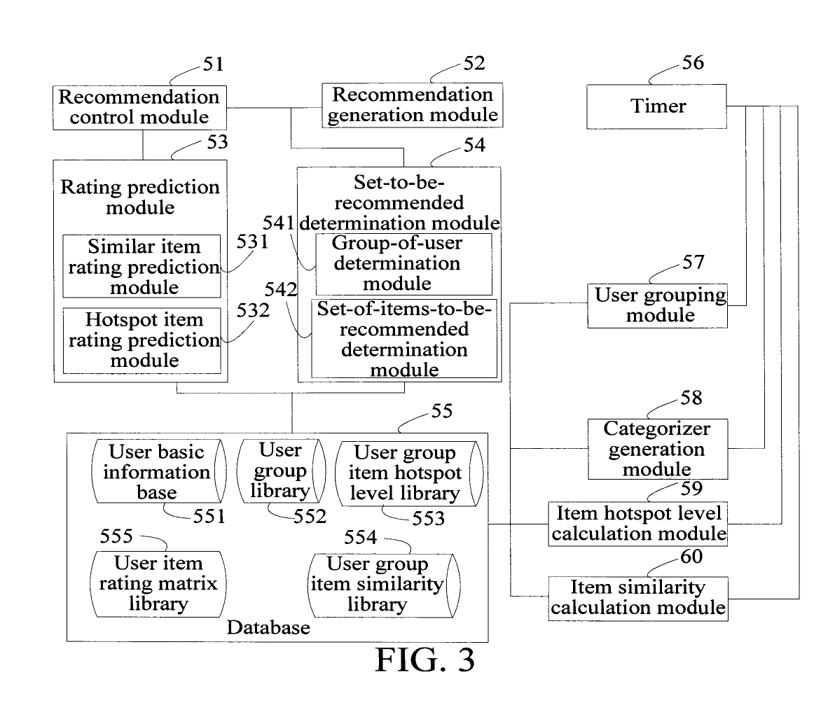

FIG. 3 is a schematic structural view of a recommendation system based on collaborative filtering according to an embodiment of the present invention. The recommendation system includes a recommendation control module 51, a recommendation generation module 52, a set-to-be-recommended determination module 54, a database S5, a rating prediction module 53, a timer 56, a user grouping module 57, a categorizer generation module 58, an item hotspot level calculation module 59, and an item similarity calculation module 60. The rating prediction module 53 further includes a similar item rating prediction module 531 and a hotspot item rating prediction module 532. The set-to-be-recommended determination module 54 further includes a group-of-user determination module 541 and a set-of-items-to-be-recommended determination module 542. The database S5 further includes a user basic information base S51, a user group library S52, a user group item hotspot level library S53, a user item rating matrix library S55, and a user group item similarity library S54. In the computing process, the storage and retrieval of data of five parts occur and are performed, which includes a system master data set and a system computation data set.

The system master data set mainly includes: user-item rating matrix data, which is specifically rating data for different items generated by each user in a service use process; and user basic information data, which is specifically basic attribute information describing the user, including geography, occupation, gender, age, and education level.

The system computation data set mainly includes: user group data, including a result of grouping users based on the user-item rating matrix data, where each user is corresponding to one group, and each group is corresponding to one group center; a user group item hotspot level database, configured to record a hotspot item and a hotspot level corresponding to each user group generated based on the user grouping result, where the hotspot items are the top M (M is not smaller than N) items rated the most, and the hotspot level of the hotspot item is an average of obtained ratings of the item; and a user group item similarity database, configured to record a similarity between items corresponding to each user group generated based on the user grouping result.

The function of each module in the recommendation system and interaction between the modules are introduced in detail below. The modules in the recommendation system are not all necessary, and a part of the modules can be added or subtracted correspondingly according to the requirements of the function or performance.

The recommendation control module 51 is a main control module of an online recommendation part, and is capable of invoking other modules after receiving a user ID (that is, a target user ID) to be recommended, so as to complete the whole recommendation process.

The set-to-be-recommended determination module 54 is configured to, after determining the corresponding target user according to the user ID to be recommended, find a set of neighboring items of a target user rating item by locating a user group to which a target user belongs, or find a set of hotspot items corresponding to the user group, obtain a set to be recommended, and use this set as a basis of next computation of the rating prediction module 53. The set-to-be-recommended determination module 54 may be further divided into the group-of-user determination module 541 and the set-of-items-to-be-recommended determination module 542. The group-of-user determination module 541 is configured to determine a user group to which a user belongs, and may locate, according to the target user ID, the user group to which the target user belongs, or determine, according to a categorizer, the user group to which the target user belongs. The set-of-items-to-be-recommended determination module 542 is configured to determine a set of items to be recommended in the group to which the target user belongs, and may obtain the set to be recommended through the set of the neighboring items of the target user rating item or the set of hotspot items corresponding to the user group. If the number of items in the set to be recommended is smaller than N, the distances between the target user and other groups are calculated. In a group with the closest distance, the process of determining the set to be recommended is continuously performed, until the number of recommended items is larger than or equal to N, or until all the user groups are traversed.

The rating prediction module 53 is mainly configured to perform a similar item-based rating prediction or a hotspot item-based rating prediction in the set of the items to be recommended obtained by the set-to-be-recommended determination module 54, so as to obtain a predicted rating made by the target user for the items to be recommended. This module may further be divided into the similar item rating prediction module 531 and the hotspot item rating prediction module 532. The similar item rating prediction module 531 calculates the predicted rating according to a similarity between similar items, for example, calculates the predicted rating according to the following formula:

$${P}_{U , i} = \frac{\sum sim ( j , i ) \cdot {R}_{U , j}}{\sum sim ( j , i )} ,$$

where P_{U,i} denotes a predicted rating made by a target user U for an item i, sim(j,i) denotes a similarity between an item j and an item i, and R_{I,j} denotes an actual rating made by the user U for the item j . The hotspot item rating prediction module 532 is configured to calculate the hotspot-item-based predicted rating. For example, a hotspot level of a hotspot item is calculated as a predicted rating of the hotspot item. In other embodiments of the present invention, the set of the items to be recommended may also be directly recommended to the user without the need of performing further predicted rating on the set of the items to be recommended.

The recommendation generation module 52 is mainly configured to use the top N items with the highest rating as a recommendation result for the target user, according to a predicted rating made by the rating prediction module 53 for each item in the set of the items to be recommended.

The user grouping module 57 is configured to group users according to a user-item rating matrix of all the users stored in the user-item rating matrix library S55 in the database 55, obtain a grouping result of all the users and a group center of each group, and store the grouping result and the group center in the user group library S52 of the database S5.

The categorizer generation module 58 is configured to, according to the user grouping result, construct and store a categorizer with basic information of each user in each user group in the user basic information base S51 in the database S5 as a categorizing feature. In other embodiments of the present invention, a categorizing training set may also take one suitable percentage according to the number of existing users, select several users are randomly from each user group based on this percentage, and use the basic information of the users as categorizing training set data.

The item hotspot level calculation module 59 is configured to, according to the user grouping result and the user-item rating matrix, independently find several items with the most rating, that is, hotspot items, from each user group, calculate an obtained rating mean, that is, a hotspot level, and store the hotspot level in the user group item hotspot level library S53 of the database S5.

The item similarity calculation module 60 is configured to, according to the user grouping result and the user-item rating matrix, independently calculate a similarity between items in each user group, and store the similarity in the user group item similarity library S54 of the database S5.

In other embodiments of the present invention, the set-of-items-to-be-recommended determination module 542 may use data stored in the item hotspot level calculation module 59 and the item similarity calculation module 60 simultaneously to determine the set of the items to be recommended for the user group to which the target user belongs, and may also use data stored in any of the above two modules upon requirements to determine the set of the items to be recommended for the user group to which the target user belongs.

The timer 56 is configured to periodically trigger the user grouping module 57, the categorizer generation module 58, the item hotspot level calculation module 59, and the item similarity calculation module 60 to process a master data set, including an updated master data set. In other embodiments of the present invention, the module is an optional module.

It can be known according to the description of the recommendation system that, when executing a specific operation, the recommendation system may be divided into two parts, namely, an offline part and an online part. The offline part periodically triggers, through the timer 56, the user grouping module 57, the categorizer generation module 58, the item hotspot level calculation module 59, and the item similarity calculation module 60, and may also trigger the modules manually. The triggering of those modules mainly provides data for computation of the online part, reduces the amount of online calculation, and increases the recommendation rate, so as to achieve the purpose of real-time recommendation. Required data is stored in the database S5. The online part is mainly configured to accomplish online recommendation for the target user. It is an important process for the online part to obtain the group to which the target user belongs, the set of the items to be recommended, and the predicted ratings for the items to be recommended, and the main task of the online part is to look for a set of items the most similar to the interest of the target user for the target user and predict a rating of the set before recommendation.

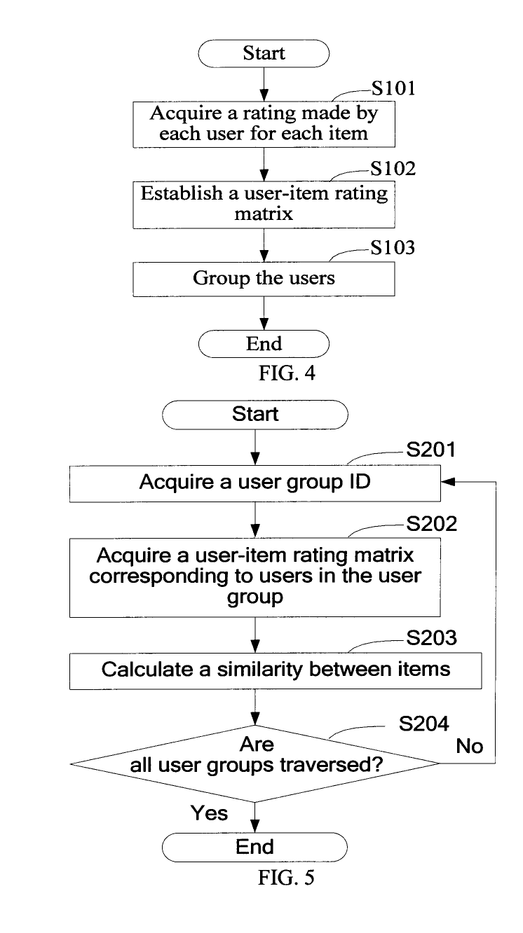

FIG. 4 is a schematic detailed flow chart of user grouping in a procedure of a recommendation method based on collaborative filtering according to an embodiment of the present invention.

In step S101, a rating made by each user for each item is acquired.

In step S102, a user-item rating matrix is established according to the user item rating. The established user-item rating matrix is shown in Table 2.

TABLE 2
User-item rating matrix

| | Item | | | | | | | |
|---|---|---|---|---|---|---|---|---|
| | Item | Item | Item | Item | Item | Item | Item | Item |
| User | 1 | 2 | 3 | 4 | 5 | 6 | 7 | 8 |
| User 1 | 5 | 3 | 4 | | | | | |
| User 2 | 4 | 2 | | 5 | | | | |
| User 3 | | 3 | 5 | 3 | | | | |
| User 4 | 4 | | 5 | 4 | | | | |
| User 5 | | | | 5 | | 3 | 5 | 2 |
| User 6 | | | 3 | | | 4 | 5 | |
| User 7 | | | 2 | 4 | | | 4 | 5 |
| User 8 | | | 3 | 5 | 4 | 5 | 4 | 3 |
| User 9 | | | 5 | 4 | | | 5 | |

In step S103, users are grouped so as to obtain several user groups and a group center of each user group.

In this embodiment, a k-means clustering algorithm based on a similarity between users is provided to group all users. In other embodiments of the present invention, a variety of grouping methods, such as manual grouping, machine grouping, and manual-machine combined grouping can be adopted.

The grouping all the users by the k-means clustering algorithm based on the similarity between the users includes the following steps. In step (1), a category quantity k and an error precision e are defined, and k users M₁, M₂, . . . , Mₖ are randomly selected as an initial group center, where M₁, M₂, . . . , Mₖ are respectively corresponding to categories C₁, C₂, . . . , Cₖ. In step (2), for each user U, a distance d(U,Mᵢ)=1−sim(U,Mᵢ),i=1, 2, . . . , k between the user and each group center is calculated, where sim(U,Mᵢ) refers to a similarity between the user U and a group center Mᵢ. The user is categorized into a group to which a group center at the closest distance from the user belongs, and a diversity

$$E ( t ) = {\sum }_{i = 1}^{k} {\sum }_{U} {δ}_{U} d ( U , {M}_{i} ) , {δ}_{U} = \{ \begin{matrix}1 , & U ∈ {C}_{i} \\ 0 , & U ∉ {C}_{i}\end{matrix}$$

is calculated, where t refers to the number of iteration times. In step (3), a new clustering center

$${M}_{i}^{′} {\sum }_{U ∈ {C}_{i}} \frac{U}{‖ U ‖ \cdot ‖ {C}_{i} ‖}$$

is calculated, where ∥U∥ refers to a modulus length of a rating vector of the user U, and ∥Cᵢ∥ refers to the total number of users in a category Cᵢ. In step (4), steps (2) and (3) are repeated until |E(t+1)−E(t)|<e. Each group is allocated with one user group ID, and meanwhile a final group center of each user group is recorded. In this embodiment, the description is given by taking that all the users are divided into two user groups as an example. Table 3 is a list of user groups.

TABLE 3
List of user groups

| | User |
|---|---|
| User group ID | User ID |
| 1 | 4 |
| 1 | 2 |
| 1 | 1 |
| 1 | 3 |
| 2 | 9 |
| 2 | 6 |
| 2 | 5 |
| 2 | 8 |
| 2 | 7 |

Group centers corresponding to User group 1 and User group 2 are shown in Table 4.

TABLE 4
Group centers corresponding to user groups

| | Item | | | | | | | |
|---|---|---|---|---|---|---|---|---|
| | Item | Item | Item | Item | Item | Item | Item | Item |
| User group | 1 | 2 | 3 | 4 | 5 | 6 | 7 | 8 |
| User group 1 | 0.46 | 0.30 | 0.46 | 0.44 | 0.00 | 0.00 | 0.00 | 0.00 |
| User group 2 | 0.00 | 0.00 | 0.32 | 0.43 | 0.08 | 0.29 | 0.58 | 0.24 |

FIG. 5 is a schematic flow chart of calculating a similarity between items in a procedure of a recommendation method based on collaborative filtering according to an embodiment of the present invention.

In step S201, a user group ID uniquely identifying each user group is acquired.

In step S202, a user-item rating matrix corresponding to all users in a corresponding user group is acquired according to the user group ID.

In step S203, a similarity between items in the user-item rating matrix corresponding to the user group is calculated and saved.

In other embodiments of the present invention, the similarity between the items may adopt a cosine similarity, a Pearson correlation coefficient, or a modified cosine similarity. In this embodiment, if the cosine similarity is adopted, the similarity between the items corresponding to each user group is obtained, as shown in Table 5 and Table 6.

TABLE 5
Similarity between items corresponding to User group 1

| | Item | | | | | | | |
|---|---|---|---|---|---|---|---|---|
| | Item | Item | Item | Item | Item | Item | Item | Item |
| Item | 1 | 2 | 3 | 4 | 5 | 6 | 7 | 8 |
| Item 1 | 1.00 | 0.65 | 0.65 | 0.67 | 0.00 | 0.00 | 0.00 | 0.00 |
| Item 2 | 0.65 | 1.00 | 0.71 | 0.57 | 0.00 | 0.00 | 0.00 | 0.00 |
| Item 3 | 0.65 | 0.71 | 1.00 | 0.61 | 0.00 | 0.00 | 0.00 | 0.00 |
| Item 4 | 0.67 | 0.57 | 0.61 | 1.00 | 0.00 | 0.00 | 0.00 | 0.00 |
| Item 5 | 0.00 | 0.00 | 0.00 | 0.00 | 1.00 | 0.00 | 0.00 | 0.00 |
| Item 6 | 0.00 | 0.00 | 0.00 | 0.00 | 0.00 | 1.00 | 0.00 | 0.00 |
| Item 7 | 0.00 | 0.00 | 0.00 | 0.00 | 0.00 | 0.00 | 1.00 | 0.00 |
| Item 8 | 0.00 | 0.00 | 0.00 | 0.00 | 0.00 | 0.00 | 0.00 | 1.00 |

TABLE 6
Similarity between items corresponding to User group 2

| | Item | | | | | | | |
|---|---|---|---|---|---|---|---|---|
| | Item | Item | Item | Item | Item | Item | Item | Item |
| Item | 1 | 2 | 3 | 4 | 5 | 6 | 7 | 8 |
| Item 1 | 1.00 | 0.00 | 0.00 | 0.00 | 0.00 | 0.00 | 0.00 | 0.00 |
| Item 2 | 0.00 | 1.00 | 0.00 | 0.00 | 0.00 | 0.00 | 0.00 | 0.00 |
| Item 3 | 0.00 | 0.00 | 1.00 | 0.69 | 0.44 | 0.56 | 0.85 | 0.45 |
| Item 4 | 0.00 | 0.00 | 0.69 | 1.00 | 0.55 | 0.62 | 0.86 | 0.81 |
| Item 5 | 0.00 | 0.00 | 0.44 | 0.55 | 1.00 | 0.71 | 0.39 | 0.49 |
| Item 6 | 0.00 | 0.00 | 0.56 | 0.62 | 0.71 | 1.00 | 0.75 | 0.48 |
| Item 7 | 0.00 | 0.00 | 0.85 | 0.86 | 0.39 | 0.75 | 1.00 | 0.66 |
| Item 8 | 0.00 | 0.00 | 0.45 | 0.81 | 0.49 | 0.48 | 0.66 | 1.00 |

In step S204, it is determined whether all the user groups are traversed. If the traverse is not completed, the procedure returns to step S201, until all the user groups are traversed. If the traverse is completed, the procedure ends.

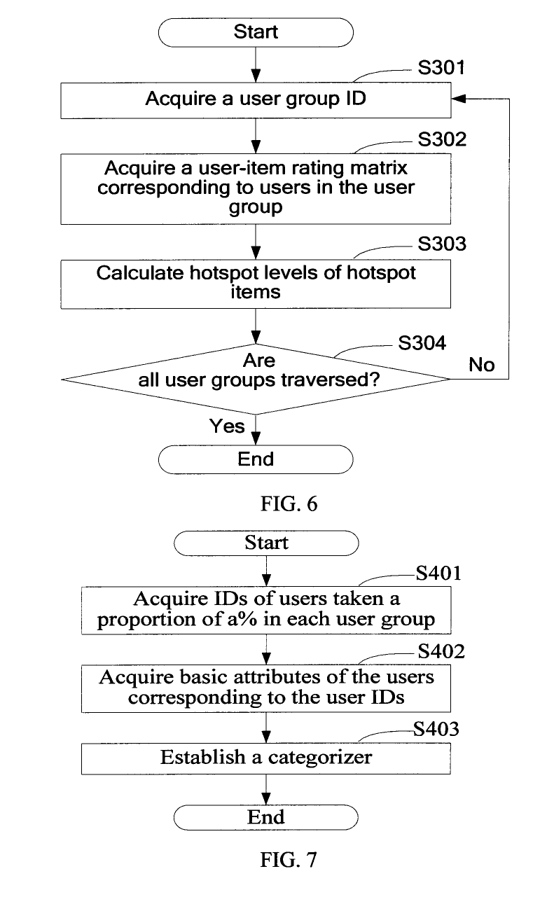

FIG. 6 is a schematic flow chart of calculating a hotspot level of an item in a procedure of a recommendation method based on collaborative filtering according to an embodiment of the present invention.

In step S301, a user group ID uniquely identifying each user group is acquired.

In step S302, a user-item rating matrix corresponding to each user in a corresponding user group is acquired according to the user group ID.

In step S303, hotspot levels of hotspot items in the user-item rating matrix corresponding to the user group are calculated.

The hotspot items are the top several items rated the most, and the hotspot level of the item is an average of the obtained ratings of the item. In this embodiment, as an example, two hotspot items are taken from each user group, and the hotspot items and hotspot levels of the items corresponding to each user group are shown in Table 7 and Table 8.

TABLE 7
Hotspot levels of items corresponding to User group 1

| Item | Hotspot level |
|---|---|
| Item 3 | 3.50 |
| Item 1 | 3.25 |

TABLE 8
Hotspot levels of items corresponding to User group 2

| Item | Hotspot level |
|---|---|
| Item 7 | 4.60 |
| Item 4 | 3.60 |

In step S304, it is determined whether all the user groups are traversed. If the traverse is not completed, the procedure returns to step S301, until all the user groups are traversed. If the traverse is completed, the procedure ends.

FIG. 7 is a schematic flow chart of establishing a categorizer in a procedure of a recommendation method based on collaborative filtering according to an embodiment of the present invention.

In step S401, IDs of users occupying a preset proportion a % of the total number of users of each user group are randomly selected.

In step S402, basic attributes of the selected users are acquired.

In step S403, features of the basic attributes of the selected users are analyzed to construct the categorizer. In the embodiments of the present invention, a variety of methods such as decision tree and neural network may be adopted to construct the categorizer.

The procedures as shown in FIGS. 4, 5, 6, and 7 may all be accomplished in an offline state. The user group data, data about similarity of items corresponding to user group, data about hotspot level of items corresponding to user group, and the categorizer are respectively generated based on the above procedures.

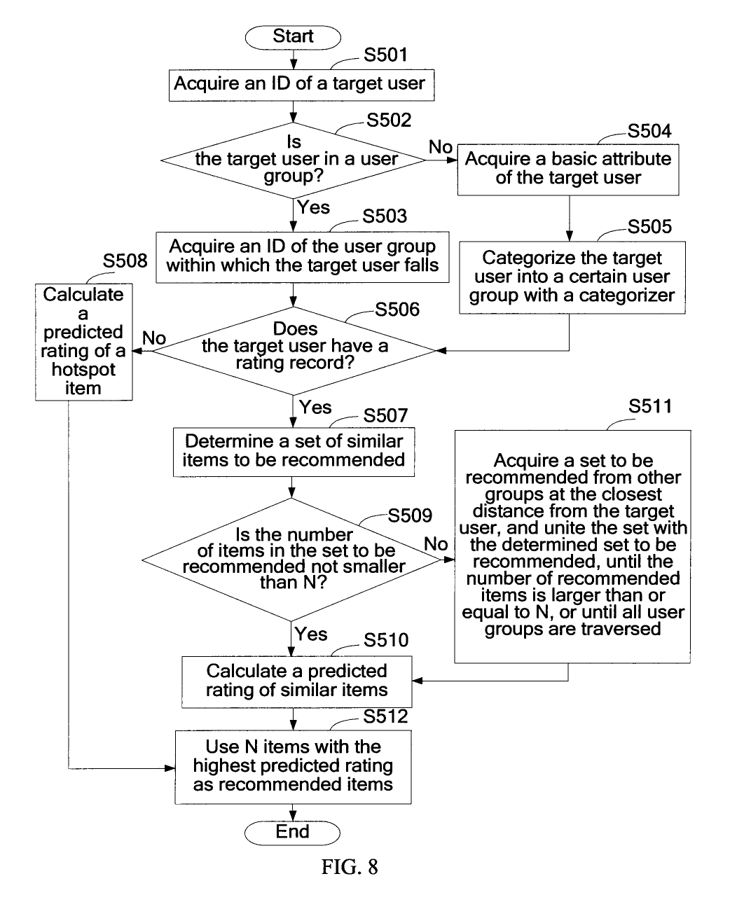

FIG. 8 is a schematic flow chart of online recommendation according to an embodiment of the present invention.

In step S501, an ID of a user to be recommended is determined. Generally, the user is referred to as a target user, that is, the ID of the target user is acquired.

In step S502, it is determined, according to the target user ID, whether the corresponding target user is in a user group. If the corresponding target user is in the user group, step S503 is performed; otherwise, step S504 is performed.

In step S503, a user group ID corresponding to the target user is acquired.

In step S504, a basic attribute of the target user is acquired.

In step S505, a categorizer is utilized to categorize the target user into a certain corresponding user group, so as to acquire a corresponding user group ID.

In step S506, it is determined whether the target user has an item rating record. If the target user has an item rating record, step S507 is performed; otherwise, step S508 is performed.

In step S507, based on an item similarity and a user item rating in the user group to which the target user belongs, items that have a high similarity to an item with a high user rating and that the target user does not rate are selected as a set to be recommended, that is, a set of similar items to be recommended is determined.

In step S508, a predicted rating made by the target user for a hotspot item of the user group to which the target user belongs is calculated. In this embodiment, the number of hotspot items may be required to be not smaller than N.

In step S509, it is determined whether the number of items in the set to be recommended is not smaller than N. If the number of items in the set to be recommended is smaller than N, step S511 is performed; if the number of items in the set to be recommended is larger than or equal to N, step S510 is performed.

In step S510, a predicted rating made by the target user for each item in the set to be recommended is calculated.

In step S511, distances between the target user and group centers of other user groups are calculated, and a set to be recommended is selected from other groups at the closest distance from the target user and is united with the set to be recommended in the foregoing step, until the number of the items in the set to be recommended is not smaller than N , or until all the user groups are traversed.

In step S512, N items with the highest predicted rating are recommended to the target user as recommended items.

In this embodiment, steps S504 and S505 are a procedure of solving a problem that when new target users are not in the existing user group, recommendation is performed after grouping the new users. It can be foreseen that, in a case without considering the new target users, steps S504 and S505 are optional steps. Step S506 provides two recommendation procedures when the target user has a rating record and has no rating record. In other embodiments of the present invention, one of the two recommendation procedures can be adopted. Steps S508, S507, and S510 also provide two recommendation algorithms simultaneously. It can be foreseen that, in other embodiments of the present invention, one of the two recommendation algorithms can be adopted randomly. Steps S509 and S511 show a procedure that when the number of the items in the set to be recommended is smaller than N, the set to be recommended is determined in an adjacent user group. It can be foreseen that, in other embodiments of the present invention, if the number of the items in the set to be recommended is not limited, steps S509 and S511 are optional steps. Step S510 is a step for increasing recommendation accuracy. In other embodiments of the present invention, if the set to be recommended is directly recommended to the user, step S510 is an optional step. In conclusion, the steps in the procedure of the method according to this embodiment can be flexibly and properly adjusted, and some of the steps may be adopted while some of the steps may be skipped according to the required recommendation accuracy, and are all capable of achieving an effect of increasing the recommendation accuracy.

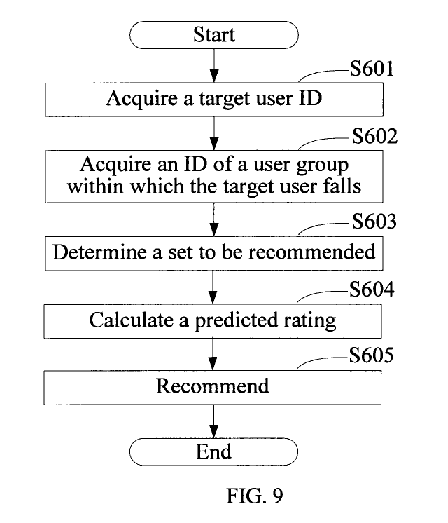

FIG. 9 shows a procedure of the method of the present invention illustrated with a specific application example according to a third embodiment of the present invention.

In step S601, a target user II) is acquired to determine a corresponding target user.

In the embodiment of the present invention, the target user is provided by a service invoking party. The service invoking party provides the target user ID, and intends to acquire a list of recommended items of the target user. It is assumed that User 7 is the target user, and Table 9 is a user-item rating matrix.

TABLE 9
User-item rating matrix

| | Item | | | | | | | |
|---|---|---|---|---|---|---|---|---|
| | Item | Item | Item | Item | Item | Item | Item | Item |
| User | 1 | 2 | 3 | 4 | 5 | 6 | 7 | 8 |
| User 1 | 5 | 3 | 4 | | | | | |
| User 2 | 4 | 2 | | 5 | | | | |
| User 3 | | 3 | 5 | 3 | | | | |
| User 4 | 4 | | 5 | 4 | | | | |
| User 5 | | | | 5 | | 3 | 5 | 2 |
| User 6 | | | 3 | | | 4 | 5 | |
| User 7 | | | 2 | 4 | | | 4 | 5 |
| User 8 | | | 3 | 5 | 4 | 5 | 4 | 3 |
| User 9 | | | 5 | 4 | | | 5 | |

In step S602, an ID of a user group to which the target user belongs is acquired. In this embodiment, it can be known from Table 3 that, User 7 belongs to User group 2. If the target user is a new user, it is needed to categorize users with user basic information so as to acquire an ID of a user group to which the new user belongs.

In step S603, a set to be recommended is determined. Firstly, items with high ratings made by User 7 are taken, and a rating made by User 7 larger than or equal to 4 is regarded as a standard for high ratings. For example, items with ratings larger than or equal to 4 are Item 4, Item 7, and Item 8. Next, items, which are with a high similarity to Item 4, Item 7, and Item 8 (the high similarity means that a mean of similarities between a selected item and Item 4, Item 7, and Item 8 is larger than 0.5) and are not rated by User 7, are obtained by searching Table 6 of the above embodiment as a set to be recommended. That is, the set to be recommended includes Item 6 and Item 3. When the number of items in a set of items to be recommended is not smaller than N (in this embodiment, it is assumed that N is equal to 1), the set to be recommended has two items, which satisfies the condition that the number of the items is not smaller than 1.

If the number of the items in the set to be recommended is smaller than 1, it is needed to calculate distances between the target user and other group centers, so as to find the closest user group and select the set to be recommended from this user group, until the total number of the items in the set to be recommended is not smaller than 1, or until all the user groups are traversed.

If the target user has no rating record, a predicted rating made by the target user for a hotspot item of a group to which the target user belongs is calculated. The predicted rating may refer to results in Tables 7 and 8 according to the above embodiment.

In step S604, the predicted rating is calculated.

A formula

$${P}_{U , i} = \frac{\sum sim ( j , i ) \cdot {R}_{U , j}}{\sum sim ( j , i )}$$

is employed for calculation, where P_{U,i} denotes a predicted rating made by a target user U for Item i, sim(j,i) denotes a similarity between Item j and Item i, and R_{U,j} denotes an actual rating made by the user U for Item j. According to the formula, predicted ratings made by User 7 for items to be recommended are shown in Table 10.

TABLE 10
Predicted ratings made by User 7 for items to be recommended

| Item | Predicted rating |
|---|---|
| Item 3 | 3.79 |
| Item 6 | 3.73 |

In step S604, items satisfying the above condition are recommended to the user. According to Table 10, finally, Item 3 is recommended to User 7.

According to the embodiments of the present invention, a recommendation method and system based on collaborative filtering are provided. In an offline processing procedure of the method, firstly, users are grouped with user item rating data, then a similarity between items is independently calculated in each user group, and a categorizer is established according to a grouping result, so that new users may also be appropriately categorized. During online recommendation, it is needed to acquire a group to which a target user belongs, and the similarity between the items related to the group is utilized to perform item-based collaborative filtering recommendation for the target user, or a hotspot level of a hotspot item related to the group is utilized to perform recommendation for the target user. Compared with a conventional collaborative recommendation procedure, in the present invention, users are firstly grouped, so that preferences of the users in each user group are substantially the same, and item similarity information contained in each user group is utilized to recommend items for the users, thereby improving the accuracy of recommendation and realizing personalized recommendation. Meanwhile, the calculating the similarity after grouping also increases the calculation speed of offline processing.

It will be apparent to persons skilled in the art that various modifications and variations can be made to the present invention without departing from the scope or spirit of the invention. In view of the foregoing, it is intended that the present invention cover modifications and variations of the present invention provided they fall within the scope of the following claims and their equivalents.

Persons of ordinary skill in the art should understand that all or a part of the steps of the method according to the embodiments of the present invention may be implemented by a program instructing relevant hardware. The program may be stored in a computer readable storage medium. When the program is run, the steps of the method according to the embodiments of the present invention are performed. The storage medium may be any medium that is capable of storing program codes, such as a ROM, a RAM, a magnetic disk, and an optical disk.

What is claimed is:

1. A recommendation method based on collaborative filtering, comprising:
acquiring a target user identifier (ID); searching a user group ID corresponding to the target user ID; acquiring a similarity between items, wherein the similarity between items is determined according to a user-item rating matrix corresponding to the user group ID; and recommending an item to a target user according to the similarity between the items.

2. The method according to claim 1, further comprising:
establishing the user-item rating matrix according to ratings made by users for the items; and calculating a similarity between the users according to the user-item rating matrix so as to group the users, wherein each user group is corresponding to a user group ID.

3. The method according to claim 2, wherein the calculating the similarity between the users according to the user-item rating matrix adopts a k-means clustering algorithm, comprising:
in step (1), defining a category quantity k and an error precision e , and randomly selecting k users Mᵢ, i=1, 2, . . . , k as an initial group center, wherein the k users are respectively corresponding to each category Cᵢ;
in step (2), for each user U , according to a similarity between each user and each group center, calculating a distance between the user and each group center; and
categorizing the user into a group to which a group center at the closest distance from the user belongs, and calculating a diversity E(t) according to the distance between the user and each group center, wherein t is the number of iteration times;
in step (3), according to a rating vector of the user U and the total number of users in the category Cᵢ, calculating a new group center; and
in step (4), repeating steps (2) and (3) until |E (t+1)−E(t)|<e.

4. The method according to claim 1, wherein the acquiring the similarity between the items, wherein the similarity between items is determined according to the user-item rating matrix corresponding to the user group ID, comprises: acquiring a user group ID; acquiring a user-item rating matrix corresponding to all users in a corresponding user group according to the user group ID; and calculating a similarity between items in the user-item rating matrix.

5. The method according to claim 4, wherein the calculating the similarity between the items in the user-item rating matrix adopts a cosine similarity, a Pearson correlation coefficient, or a modified cosine similarity to calculate.

6. The method according to claim 1, wherein if the corresponding user group ID is not searched according to the target user ID, a categorizer is adopted to categorize the target user into a corresponding user group, comprising: acquiring a basic attribute of the target user corresponding to the target user ID; and categorizing, by the categorizer, the target user into the corresponding user group according to the basic attribute of the target user, and obtaining a user ID corresponding to the user group.

7. The method according to claim 6, wherein a method for establishing the categorizer comprises: randomly selecting from each user group IDs of users occupying a preset proportion a % of the total number of users in the user group; acquiring basic attributes of the selected users in the preset proportion a %; and constructing the categorizer according to features of the basic attributes of the selected users in the preset proportion a %.

8. The method according to claim 1, wherein the recommending the item to the target user according to the similarity between the items comprises:
judging whether the target user has rating records in the user-item rating matrix corresponding to the user group, and if the target user has rating records in the user-item rating matrix corresponding to the user group, through the similarity between the items, determining items similar to items corresponding to the rating records as a set to be recommended.

9. The method according to claim 1, wherein the recommending the item to the target user according to the similarity between the items comprises:
judging whether the target user has rating records in the user-item rating matrix corresponding to the user group, and if the target user does not have rating records in the user-item rating matrix corresponding to the user group, calculating predicted ratings of hotspot items in the user-item rating matrix, and using the hotspot items as a set to be recommended, wherein the hotspot items are the top M items rated the most.

10. The method according to claim 9, wherein for the hotspot items in the user-item rating matrix, the calculating the hotspot item-based predicted ratings comprises: acquiring a user group ID; acquiring a user-item rating matrix corresponding to all users in a corresponding user group according to the user group ID; and calculating a hotspot level of a hotspot item in the user-item rating matrix corresponding to the user group, wherein the hotspot level of the hotspot item is an average of obtained ratings of the item, and the hotspot level of the hotspot item is a predicted rating of the hotspot item.

11. The method according to claim 8, further comprising: judging whether the number of items in the set to be recommended is not smaller than N, and if the number of items in the set to be recommended is not smaller than N, acquiring a set to be recommended in other user groups at the closest distance from the target user, and uniting the acquired set to be recommended with the determined set to be recommended, until the number of recommended items is larger than or equal to N, or until all the user groups are traversed.

12. The method according to claim 8, further comprising: judging whether the number of items in the set to be recommended is smaller than N, and if the number of items in the set to be recommended is larger than or equal to N, calculating a predicted rating of each item in the set to be recommended, and recommending the top N items with the highest predicted rating to a user as recommended items.

13. A recommendation system based on collaborative filtering, comprising:
a recommendation control module, configured to acquire a target user ID, and invoke a set-to-be-recommended determination module and a recommendation generation module to recommend an item to a target user corresponding to the target user ID;
the set-to-be-recommended determination module, configured to search a user group ID corresponding to the target user ID, acquire a similarity between items, wherein the similarity between items is determined according to a user-item rating matrix corresponding to the user group ID, determine, according to the similarity between the items, a set to be recommended, or acquire a set of hotspot items, wherein the set of hotspot items is determined according to the user-item rating matrix corresponding to the user group ID, and use the set of the hotspot items as the set to be recommended; and
the recommendation generation module, configured to recommend an item in the set to be recommended to a user.

14. The system according to claim 13, further comprising: a database, comprising a user-item rating matrix library, configured to store a user-item rating matrix made by each user for each item.

15. The system according to claim 14, comprising: a user grouping module, configured to group users according to the user-item rating matrix stored in the user-item rating matrix library in the database, wherein each user group is corresponding to a user group ID and a group center, and a user grouping result is stored in a user group library in the database.

16. The system according to claim 14, wherein the database further comprises: a user basic information base, configured to store basic information of each user.

17. The system according to claim 15, comprising: a hotspot item hotspot level calculation module, configured to independently find several items with the most rating as hotspot items in each user group according to the user grouping result and the user-item rating matrix corresponding to the user group, and calculate a rating mean of the hotspot item to obtain a hotspot level of the hotspot item.

18. The system according to claim 16, further comprising: a categorizer generation module, configured to use the basic information corresponding to the user in each user group as a categorizing feature according to the user grouping result so as to construct a categorizer.

19. The system according to claim 17, comprising: an item similarity calculation module, configured to independently calculate the similarity between the items in each user group according to the user grouping result and the user-item rating matrix corresponding to the user group.

20. The system according to claim 19, wherein the database further comprises: a user group item similarity library, configured to store the similarity between the items corresponding to the user group.
